(19) United States
(12) Patent Application Publication
(10) Pub. No.: US 2018/0134196 A1
(43) Pub. Date: May 17, 2018

(54) MOVABLE ARMREST ASSEMBLY

(71) Applicant: VOLVO CONSTRUCTION EQUIPMENT AB, Eskilstuna (SE)

(72) Inventor: Maciej KARCZ, Losiow (PL)

(73) Assignee: VOLVO CONSTRUCTION EQUIPMENT AB, Eskilstuna (SE)

(21) Appl. No.: 15/577,871

(22) PCT Filed: Jul. 20, 2015
(86) PCT No.: PCT/EP2015/066516

§ 371 Date: Nov. 29, 2017

(51) Int. Cl. B60N 2/75

(52) U.S. Cl. CPC B60N 2/773; B60N 2/777

(57) ABSTRACT

A movable armrest provides the movement and rotation of the armrest in various directions during the manipulation of the joystick by an operator. The movable armrest includes: an armrest configured to support operator's arm during the manipulation of a joystick; a housing configured to accommodate the armrest; four helical springs configured to connect between the armrest and the housing; and one or more ball transfer units configured to reduce a friction between the armrest and the housing to function to provide a smooth movement of the armrest. The armrest can move in parallel with the ground surface or rotate about an axis perpendicular to the around surface on the housing in response to a change in the position of the operator's arm. When the operator puts away his or her arm from the armrest, the armrest can return to a default position where the tensions of the helical springs form a balance by means of the helical springs.

### BACKGROUND AND SUMMARY

The present disclosure generally relates to a movable armrest assembly of a construction machine, and more particularly, to a movable armrest which can move in various directions.

Every construction machine needs to fulfil many ergonomics issues. It is noticeable that construction machines become more and more operator friendly from year to year. An operator's daily work is very monotonous, e.g. the operator uses only his or her right hand for manipulating a joystick. During this activity, the operator overloads the wrist and the elbow joint. To relieve the overloads imposed on the wrist and the elbow joint and make a work more ergonomic, a movable armrest can be applied to machines.

On the market, there are not many solutions that increase the ergonomic effects in the manipulation area of hand. Therefore, there is a need for the introduction of an advanced movable armrest which can relieve the overloads imposed on the elbow joint and the wrist at the same time and relieve an overload imposed on the shoulder joint as well.

It is important to help an operator to maintain a comfortable posture during the manipulation of a joystick or the like to increase the working efficiency. Thus, there are prior arts that can adjust an armrest. For example, there is disclosed a technology which fixes an operator's arm to a comfortable position by pushing the armrest in a horizontal or vertical direction. However, such a conventional technology entails a problem in that only one dimensional movement is provided or the operator suffers from an inconvenience of having to previously adjust the position of the armrest before the start of a work.

A movable armrest assembly according to an aspect of the present disclosure provides an armrest whose position does not need to be previously adjusted separately before the start of a work and which enables an operator's arm to be placed on the most natural and comfortable position. The movable armrest assembly according to an aspect of the present disclosure includes an armrest that supports an operator's arm during the manipulation of the machine, a housing that accommodates the armrest, four helical springs that connect between the armrest and the housing, and at least one ball transfer unit that reduces a friction between the armrest and the housing to function to provide a smooth movement of the armrest.

The armrest can move in parallel with the ground surface or rotate about an axis perpendicular to the ground surface on the housing in response to a change in the position of the operator's arm. When the operator puts away his or her arm from the armrest, the armrest can return to a default position where the tensions of the helical springs form a balance by means of the helical springs.

The present disclosure provides a solution making it possible to conduct a manual operation without losing a contact between an arm of the operator and an armrest. According to one embodiment of the present disclosure, the operator can control the joystick more comfortably and efficiently. In addition, the armrest according to the present disclosure is simple in structure so that it can be manufactured with low cost. The armrest according to the present disclosure has a low interference in existing machine. Especially, the present disclosure can be used in a wide range of construction machines and increase machine ergonomics by reliving the overload imposed on a wrist and an elbow joint of the operator. The helical spring system of the present disclosure allows an armrest to be always maintained at a default position so that the operator does not need to adjust the default position after the completion of the work.

### BRIEF DESCRIPTION OF THE DRAWINGS

FIG. 1 is a schematic drawing showing a state in which an operator clamps a joystick;

FIG. 2 is a side view of a movable armrest assembly according to an embodiment of the present disclosure;

FIG. 3 is a top view of a movable armrest assembly according to an embodiment of the present disclosure;

FIG. 4 is a perspective view of a movable armrest assembly according to an embodiment of the present disclosure

FIG. 5a is a ball transfer unit of a movable armrest assembly according to an embodiment of the present disclosure;

FIG. 5b is a partial cross-sectional view of a ball transfer unit according to an embodiment of the present disclosure; and

FIG. 6 shows various possible positions of the movable armrest assembly according to an embodiment of the present disclosure;

### DETAILED DESCRIPTION

The foregoing description of the embodiments of the present disclosure has been presented for the purpose of illustration, but it is not intended to be exhaustive or to limit the present disclosure to the precise forms disclosed. Persons skilled in the related an can appreciate that many modifications and variations are possible in light of the above teachings. It is therefore intended that the scope of the invention be limited not by this detailed description, but rather by the claims appended hereto.

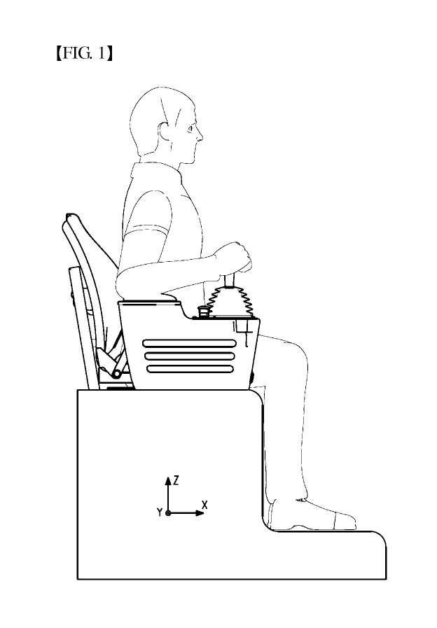

FIG. 1 is a schematic drawing showing a state in which an operator clamps a joystick.

In a construction machine, an operator performs a work by gripping and manipulating a joystick with him or her seated on an operator's seat. There is a need for a supporting member that can bear the operator's arm or elbow with him or her gripping the joystick in order for him or her to perform the work for a long time without feeling a fatigue. This supporting member is generally called an armrest.

The operator moves the joystick in all direction on a plane during the work. In this case, the operator's arm also moves on the armrest along with the movement of the joystick. In the case where the armrest is designed too narrowly as compared to a distance where the joystick moves or is designed in a fixed state, a situation may occur in which it is difficult for the armrest to comfortably support the operator's arm during the manipulation of the joystick by the operator.

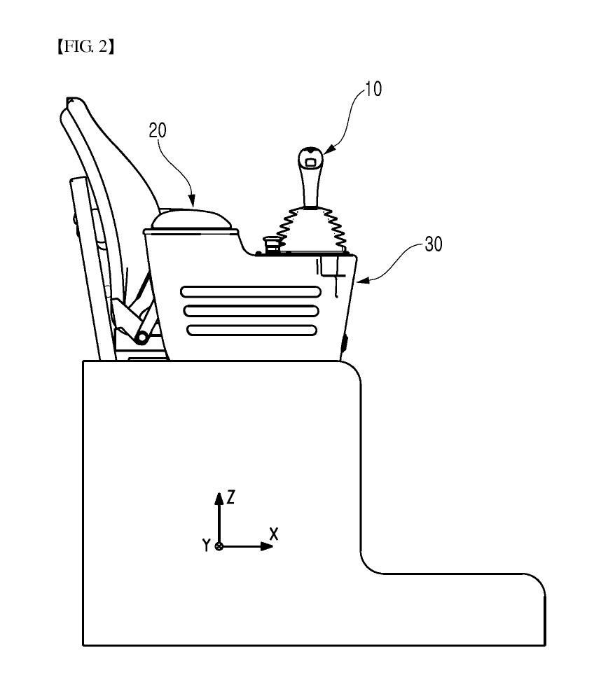

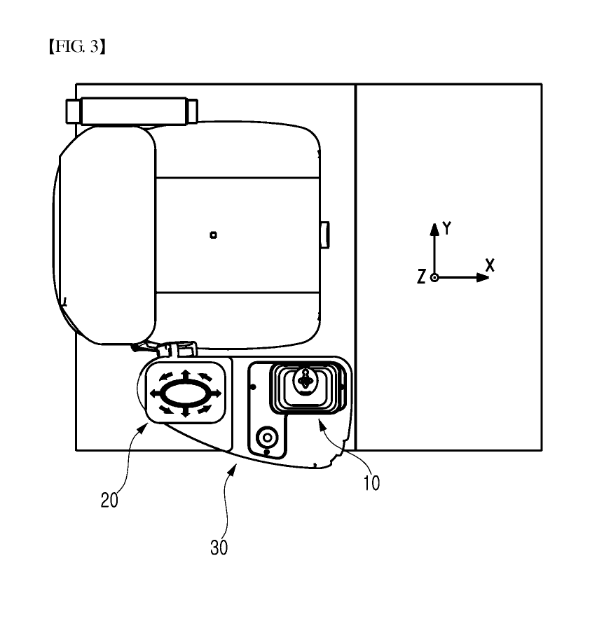

FIG. 2 is a side view of a movable armrest assembly according to an embodiment of the present disclosure, and FIG. 3 is a top view of a movable armrest assembly according to an embodiment of the present disclosure.

The movable armrest assembly according to an embodiment of the present disclosure is positioned at the right side of the operator's seat, but this is an arbitrary position. The movable armrest assembly may be disposed at the right or left side of the operator's seat depending on the arrangement of the joystick and the operator's preference of the manipulation position of the joystick, or whether the operator is a righthander or a left-hander.

In an embodiment of the present disclosure, the joystick moves in directions (i.e., X and Y directions in the drawing) parallel with the ground surface, which is set as a reference. The armrest may be disposed to support the operator's arm or elbow region.

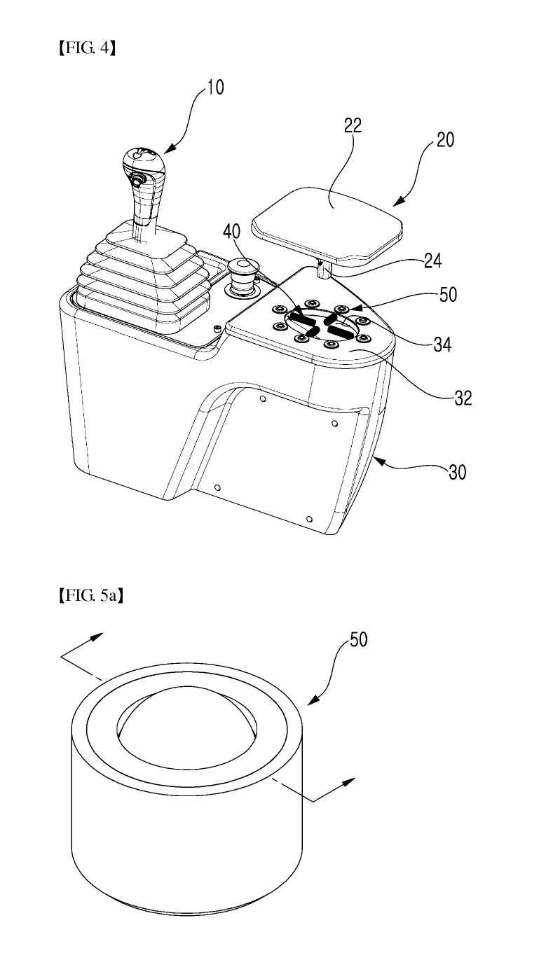

FIG. 4 is a perspective view of a movable armrest assembly according to an embodiment of the present disclosure.

The movable armrest assembly according to an embodiment of the present disclosure includes an armrest 20 that support the operator's arm during the manipulation of the joystick 10. A plate 22 of the armrest can be formed to have a proper size capable of supporting the operator's arm and elbow. The plate may have a flat or slightly curved shape to allow the operator's arm to be comfortably held thereon. In FIGS. 1 to 3, there is shown a cushioning plate having a curved shape, and a flat-shaped plate is shown in FIG. 4.

A connecting rod 24 extending vertically downwardly from the plate is formed at a lower portion of the armrest. The connecting rod 24 is can function as a connection element that is connected to one ends of the helical springs 40 which will be described later.

The movable armrest assembly according to an embodiment of the present disclosure includes a housing 30 that accommodates the armrest More specifically, the housing 30 can include a plate support 32 that can support the plate 22 of the armrest, and an accommodating portion 34 that is sized to accommodate the connecting rod 24 of the armrest. As can be seen from FIGS. 4 and 6, the plate of the armrest is configured to have an area larger than that of the accommodating portion of the housing so that the plate can be placed on a top surface of the housing. In addition, the connecting rod of the armrest is accommodated in the accommodating portion of the housing so that the movement of the armrest can be restricted to the accommodating portion of the housing. For example, the accommodating portion of the housing may be formed in an elliptical shape so that the movement of the armrest can be restricted to the elliptical-shaped accommodating portion. The connecting rod of the armrest is connected to one ends of the helical springs 40, and the accommodating portion of the armrest is connected to the other ends of the helical springs 40.

The movable armrest assembly according to an embodiment of the present disclosure includes four helical springs 40 that connects between the armrest and the housing. In FIG. 4, the helical springs 40 are connected at one ends thereof to the connecting rod of the armrest, and are connected to at the other ends thereof to the accommodating portion of the armrest.

By virtue of the helical springs, the armrest can move in parallel with the ground surface or rotate about an axis perpendicular to the ground surface on the housing in response to a change in the position of the operator's arm.

In addition, when the operator puts away his or her arm from the armrest, the armrest can return to a default position where the tensions of the helical springs forma balance by means of the helical springs.

Preferably, the four helical springs are disposed symmetrically relative to the center of the housing, and the default position of the armrest where the tensions of the helical springs form a balance is held at the center of the housing, more preferably at the center of the accommodating portion of the housing.

The movable armrest assembly according to an embodiment of the present disclosure as shown in FIG. 4 includes four helical springs, but the movable armrest assembly according to another embodiment of the present disclosure may further include additional helical springs that connect between the armrest and the housing. Similarly to the aforementioned embodiment, the additional helical springs are also disposed symmetrically relative to the center of the housing, and the default position of the armrest is held at the center of the housing.

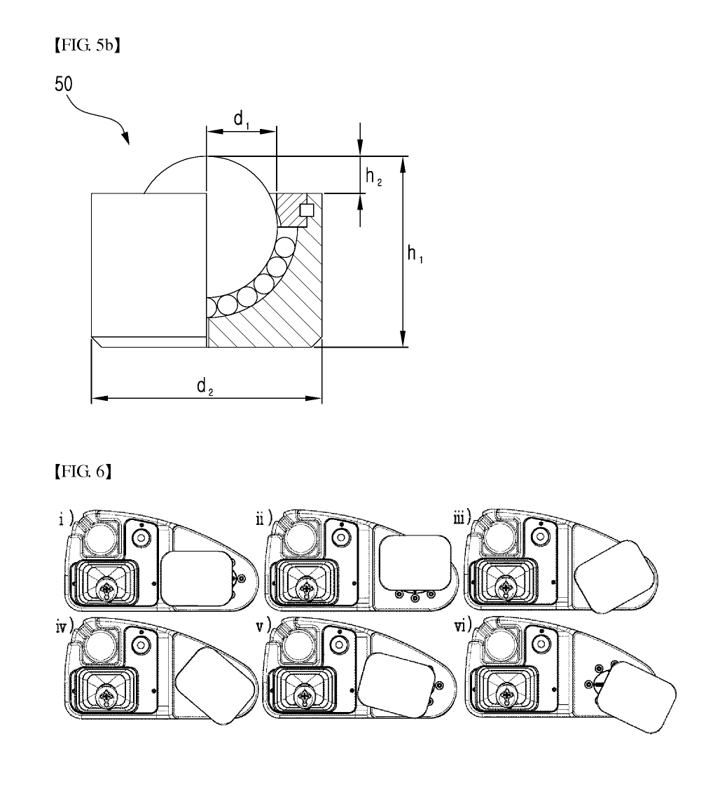

FIG. 5a is a ball transfer unit of a movable armrest assembly according to an embodiment of the present disclosure, and FIG. 5b is a partial cross-sectional view of a ball transfer unit according to an embodiment of the present disclosure.

The movable armrest assembly according to an embodiment of the present disclosure includes at least one ball transfer unit that reduces a friction between the armrest and the housing to function to provide a smooth movement of the armrest. The ball transfer unit is a kind of bearing in which a ball is mounted inside a spherical-shaped fixing member to have omni-directionality. The ball transfer unit illustratively used in this embodiment may include a single large ball that is supported by a small ball bearing.

The ball transfer unit 50 can be disposed on the plate support of the housing within a zone where the armrest is movable. In this case, the balls of the ball transfer units are brought into close contact with the underside of the plate of the armrest.

In another embodiment, the ball transfer units 50 may be disposed on the underside of the plate of the armrest. In this case, the balls of the ball transfer units are brought into close contact with the top surface of the plate support of the housing.

Preferably, the ball transfer units 50 are provided in even number, and the even-numbered ball transfer units can be disposed symmetrically relative to the center of the default position of the armrest. As shown in FIG. 5, the ball transfer unit has an entire height of hi, and is protruded to the outside by a given height upon the mounting of the ball transfer unit on the housing or the plate. In the case where the ball transfer unit is mounted on the housing or the plate, a gap is defined between the plate of the armrest and the plate support of the housing by the height by which the ball transfer unit is protruded, and thus the ball transfer units are preferably disposed symmetrically relative to the center of the default position of the armrest so that the gap is constantly maintained between the plate and the plate support.

FIG. 6 shows various possible positions of the movable armrest assembly according to an embodiment of the present disclosure;

FIG. 6(i) shows a state in which the armrest is adjusted in position to the front relative to the joystick, FIG. 6(ii) shows a state in which the armrest is adjusted in position, i.e., is moved to the right, FIG. 6(iii) shows a state in which the armrest is rotated in a counter-clockwise direction, FIG. 6(iv) shows a state in which the armrest is rotated in a clockwise direction, FIG. 6(v) shows a state in which the armrest is adjusted in position, i.e., is moved to the left front position after the rotation of the armrest in the clockwise direction, and FIG. 6(vi) shows a state in which the armrest is adjusted in position, i.e., is moved to the left back position after the rotation of the armrest in the clockwise direction.

In the movable armrest assembly according to the present disclosure, the operator can change the position of the armrest smoothly on the housing through the ball transfer units with him or her arm put on the armrest, and can rotate the armrest. Further, when the operator put away his or her arm from the armrest, the armrest can return to the default position by means of the helical springs.

1. A movable armrest assembly of a construction machine, comprising:
an armrest configured to support an operator's arm during the manipulation of a joystick;
a housing configured to accommodate the armrest;
four helical springs configured to connect between the armrest and the housing; and
one or more ball transfer units configured to reduce a friction between the armrest and the housing to function to provide a smooth movement of the armrest,
wherein the armrest moves in parallel with the ground surface or rotate about an axis perpendicular to the ground surface on the housing in response to a change in the position of the operator's arm, and
wherein when the operator puts away his or her arm from the armrest, the armrest returns to a default position where the tensions of the helical springs form a balance by means of the helical springs.

2. The movable armrest assembly according to claim 1, wherein the armrest comprises:
a plate configured to allow the operator's arm to be held thereon; and
a connecting rod extending vertically downwardly front the plate,
wherein the connecting rod is connected to one ends of the helical springs.

3. The movable armrest assembly according to claim 2, wherein the housing comprises:
a plate support configured to support the plate of the armrest; and
an accommodating portion sized to accommodate the connecting rod of the armrest,
wherein the accommodating portion is connected to the other ends of the helical springs.

4. The movable armrest assembly according to claim 3, wherein the accommodating portion of the housing is formed in an elliptical shape so that the movement of the armrest is restricted to the elliptical-shaped accommodating portion.

5. The movable armrest assembly according to claim 1, wherein the helical springs are disposed symmetrically relative to the center of the housing, and the default position of the armrest is held at the center of the housing.

6. The movable armrest assembly according to claim 1, further comprising additional helical springs configured to connect between the armrest and the housing.

7. The movable armrest assembly according to claim 3, wherein the ball transfer units are disposed on the plate support of the housing within a zone where the armrest is movable.

8. The movable armrest assembly according to claim 3, wherein the ball transfer units are disposed on the underside of the plate of the armrest, and function to reduce a friction between the plate support of the housing and the plate of the armrest to provide a smooth movement of the armrest

9. The movable armrest assembly according to claim 1, wherein the ball transfer units are provided in even number, and the even-numbered ball transfer units can be disposed symmetrically relative to the center of the default position of the armrest.
